(19) United States
(12) Patent Application Publication
(10) Pub. No.: US 2007/0186758 A1
(43) Pub. Date: Aug. 16, 2007

(54) Apparatus and method for controlling backround music in mobile communication system

(75) Inventors: Hyo-Jin Kim, Suwon-si (KR); Khi-Soo Jeong, Hwaseong-si (KR); Sang-In Lee, Seoul (KR); Eun-Chul Kim, Seoul (KR); Hyun-Jeong Shim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/788,137

(22) Filed: Apr. 19, 2007

(30) Foreign Application Priority Data
Jun. 8, 2005 (KR) 2006-0051287

(51) Int. Cl. G10H 7/00

(52) U.S. Cl. 84/622

(57) ABSTRACT

A method and apparatus for controlling a background music (BGM) play operation is disclosed. The method determines if a predetermined hotkey is pressed during the BGM play operation and, if pressed, a BGM play control box is displayed while maintaining the state of an ongoing main operation. Function mapping of a series of predetermined keys is then changed. If determined that the predetermined key is pressed for control of the BGM play operation, the BGM play operation is controlled according to the mapped function of the pressed key. The BGM play control operation can be adjusted using the predetermined hotkey without converting the BGM play operation into the main operation.

### PRIORITY

This application claims priority under 35 U.S.C. § 119 to an application filed in the Korean Intellectual Property Office on Jun. 8, 2006 and allocated Serial No. 2006-51287, the contents of which are incorporated herein by reference.

### BACKGROUND OF THE INVENTION

1. Field of the Invention

The present invention relates generally to a mobile communication system, and, in particular, to an apparatus and method for controlling background music (BGM) in a mobile communication system by using a key mapped to a predetermined hotkey.

2. Description of the Related Art

Since mobile communication service using portable terminals was commercialized, the number of service users has increased rapidly. In addition, as the number of the service users has increased, the requirements of service providers and users for the mobile communication service and the portable terminals have also increased.

According to the above requirements, the portable terminals have been developed to provide not only conventional voice call service but also an Internet service through data communication, a home banking service through the Internet service, and a multimedia file service.

In accordance with the multimedia file service, the portable terminal provides a multimedia file play function and thus functions as a Personal Multimedia Player (PMP), beyond a simple communication terminal.

In addition, the portable terminal can provide a multitasking function that makes it possible to process a plurality of tasks simultaneously. Using the multitasking function, the portable terminal can provide a function of playing background music during the performance of other operations.

FIG. 1 illustrates conventional icons for controlling background music. Referring to FIG. 1, a conventional function of playing a multimedia file as background music displays only an icon on a screen to merely inform that the multimedia file is being played, but cannot provide a means for controlling the music that is playing. That is, while playing the multimedia file, the playing operation must be converted into the main operation in order to control the playing of music.

What is therefore required is an apparatus and method that can control the music playing (e.g., BGM) during the playing of the music without converting the music play operation into the main operation.

### SUMMARY OF THE INVENTION

An object of the present invention is to substantially solve at least the above problems and/or disadvantages and to provide at least the advantages below. Accordingly, an object of the present invention is to provide an apparatus and method for controlling background music in a mobile communication system.

Another object of the present invention is to provide an apparatus and method for controlling, when a specific operation is being performed in a background mode in a mobile communication system, the specific operation in the background mode without converting the specific operation into the main operation.

A further object of the present invention is to provide an apparatus and method for controlling, when a BGM play operation is being performed in a background mode in a mobile communication system, the BGM play operation without converting the BGM play operation into the main operation.

Still another object of the present invention is to provide an apparatus and method for controlling a BGM play operation on any menu in a mobile communication system merely by handling a predetermined key.

According to one aspect of the present invention, there is provided a method for controlling a BGM play operation that is performed in a background mode in a mobile communication system, the method including determining if a predetermined hotkey is pressed during the BGM play operation; if the predetermined hotkey is pressed, displaying a BGM play control box while maintaining the state of an ongoing main operation; changing the function mapping of a series of predetermined keys; determining if the predetermined key is pressed for control of the BGM play operation; and if the predetermined key is pressed, controlling the BGM play operation according to the mapped function of the pressed key.

According to another aspect of the present invention, there is provided an apparatus for controlling a BGM play operation that is performed in a background mode in a mobile communication system, the apparatus includes a controller for commanding, upon detection of pressing of a predetermined hotkey, a BGM processor to control the BGM play operation while maintaining the state of an ongoing main operation; and the BGM processor for displaying a BGM play control box in response to the BGM play control command from the controller and controlling the BGM play operation upon detection of pressing of a series of predetermined keys to which functions for control of the BGM play operation are mapped.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates conventional icons for controlling background music;

FIG. 2 is a block diagram of an apparatus for controlling background music according to the present invention;

FIG. 3 is a flowchart illustrating a procedure for controlling background music according to the present invention;

FIGS. 4A and 4B illustrate the key mapping for a BGM play control box according to the present invention; and

FIGS. 5A and 5B illustrate a BGM control screen according to the present invention.

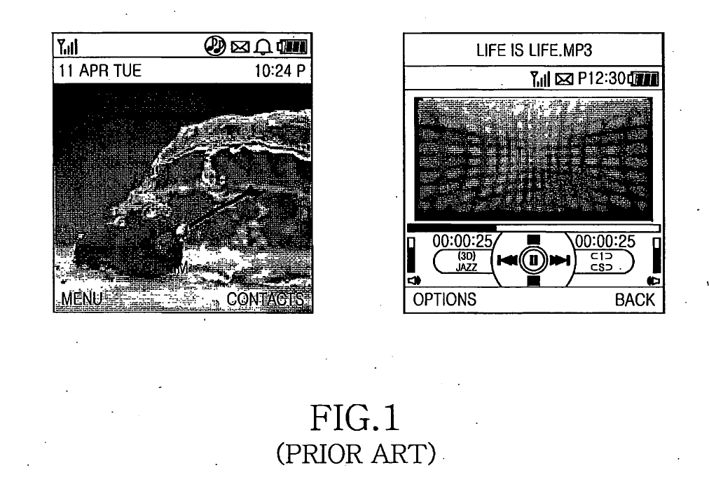

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

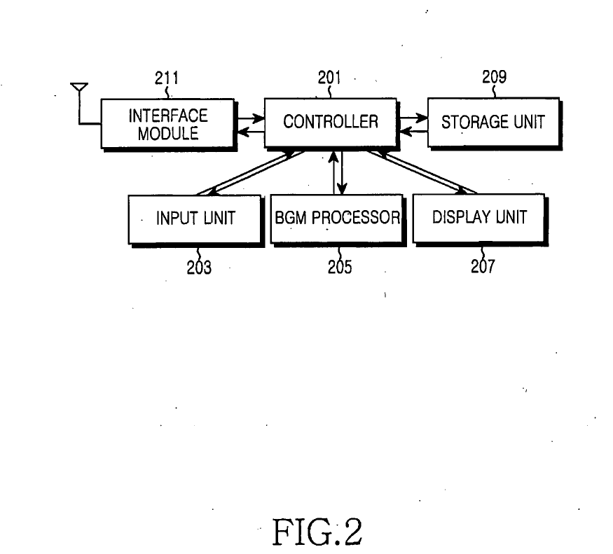

FIG. 2 is a block diagram of an apparatus for controlling background music according to the present invention. Referring to FIG. 2, the apparatus includes a controller 201, an input unit 203, a BGM processor 205, a display unit 207, a storage unit 209, an interface module 211, and an antenna. The controller 201 controls overall operation of the apparatus. For example, if the controller 201 is the main controller of a portable terminal, it processes and controls voice communication and data communication. In addition to general functions, the controller 201 detects the input of a predetermined hotkey and controls the BGM processor 205 so that background music can be controlled during a play operation thereof merely by use of a predetermined key without conversion of the BGM play operation into the main operation. The BGM play operation can also be controlled with it converted into the main operation.

The predetermined hotkey may be defined as the long pressing of a specific key, e.g., a left volume key, of the apparatus or may be implemented using a separate key that is added to the apparatus.

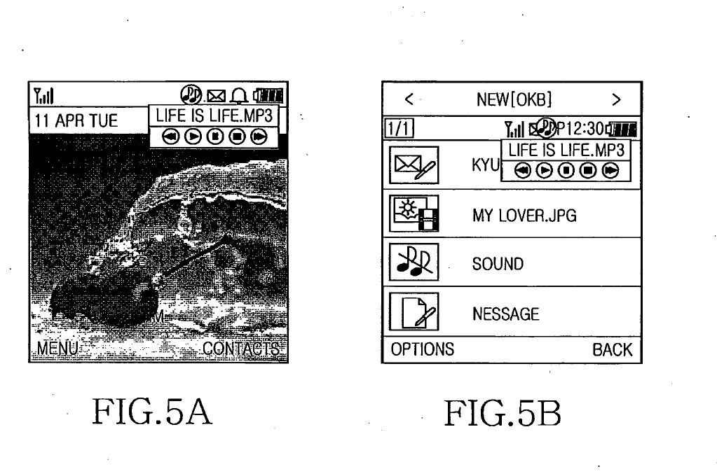

During a BGM play operation, on the basis of the command and data received from the controller, the BGM processor 205 displays a BGM play control box at an upper right portion of a screen, as illustrated in FIG. 5A, receives a key input for the BGM play operation from the input unit 203, and controls a function related to the BGM play operation.

The key input for the BGM play operation is preferably an input of a key whose function is converted by the function mapping of a series of predetermined keys. The function mapping is an operation of mapping functions for the BGM play control to a series of the predetermined keys. Examples of the functions for the BGM play control are “Pause”, “Resume”, “Fast Forward (FF)”, “Rewind (REW)”, and “Stop”.

When the predetermined hotkey is pressed again, the controller 201 commands the deactivation of the display and control of the BGM play control box. Accordingly, the BGM processor 205 terminates the display of the BGM play control box and resumes the original functions of the predetermined keys.

According to the present invention, the BGM play operation is performed in a background mode, rather than in a main mode, during the use of a BGM play control function. When the predetermined hotkey is pressed, e.g., the long pressing of a volume key, during the BGM play operation, the BGM play control box is displayed, such as illustrated in FIG. 5B.

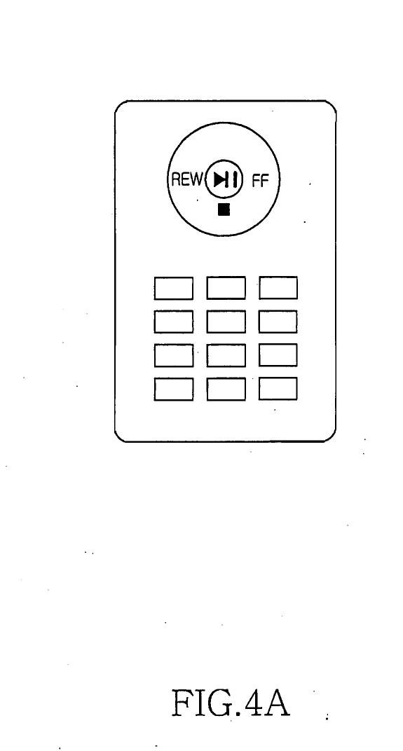

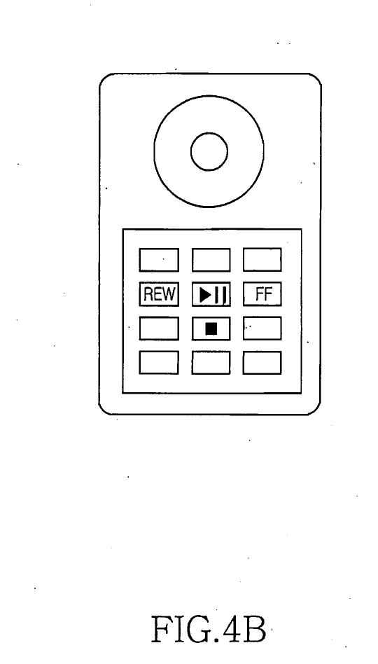

The BGM play control box uses a mapping scheme as illustrated in FIG. 4A or 4B. As illustrated in FIGS. 4A and 4B, a navigation key or a predetermined button key may be used to control the BGM play control function. In addition, the title of a playing file may be displayed in the BGM play control box. That is, the BGM play control box is used to display mapped functions of a series of the predetermined keys or a key array corresponding to the mapped functions.

Thereafter, when the predetermined hotkey is pressed again to deactivate the BGM play control function, the mapped key settings are converted into the original state. The design of the BGM play control box may be changed using a skin concept.

Storage unit 209 stores a program for controlling the overall operation of the apparatus and temporary data that are generated during the execution of the program. Interface module 211 is used to communicate with other nodes and includes an RF processor and a baseband processor. The RF processor converts a signal received through the antenna into a baseband signal, and provides the baseband signal to the baseband processor. In addition, the RF processor converts a baseband signal received from the baseband processor into an RF signal that is transmissible on the air, and transmits the RF signal through the antenna.

In a broadband wireless access scheme, the baseband processor performs a Fast Fourier transform (FFT) operation and a channel decoding operation on a signal received from the RF processor to restore original information data, and provides the original information data to the controller 201. In addition, the baseband processor performs a channel coding operation and an Inverse FFT (IFFT) operation on data received from the controller 201 and provides the resulting data to the RF processor.

In a Code Division Multiple Access (CDMA) scheme, the baseband processor despreads a signal received from the RF processor to restore original information data, and provides the original information data to the controller 201. In addition, the baseband processor spreads data received from the controller 201 and provides the resulting data to the RF processor. Alternatively, the controller 201 may be designed to perform the functions of the BGM processor 205. The controller 201 may be designed to perform all or some of the functions of the BGM processor 205.

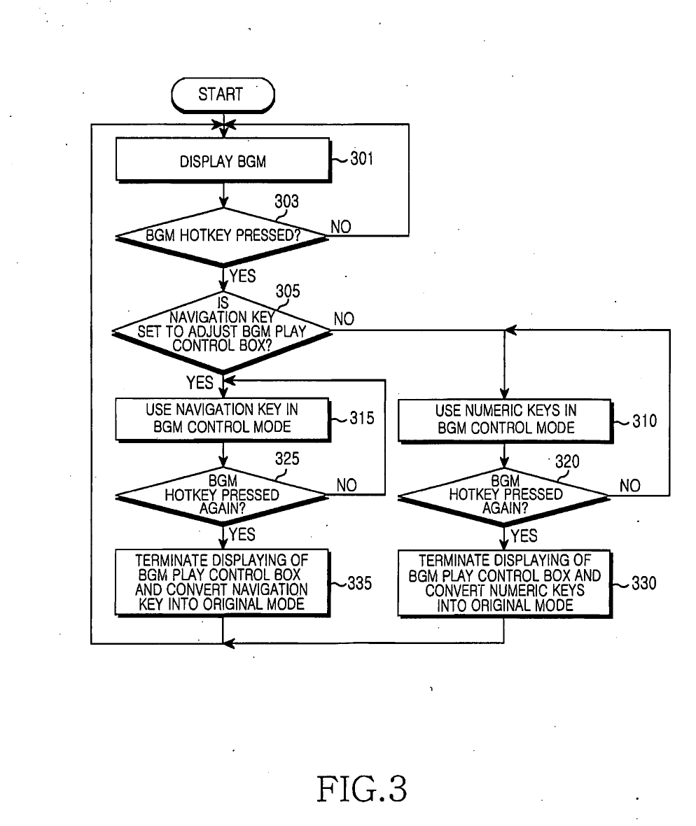

FIG. 3 is a flowchart illustrating a procedure for controlling background music according to the present invention. Referring to FIG. 3, the apparatus of the present invention starts to perform a BGM play operation according to the user's selection in step 301.

In step 303, the apparatus determines if a hotkey for BGM play control is pressed. If so, the procedure proceeds to step 305; and, if not, the procedure returns to step 301. The BGM play control hotkey in step 303 is a hotkey for displaying the BGM play control box in a background mode.

If the hotkey for BGM play control is pressed, as determined in step 305, the apparatus determines if a navigation key is set to adjust the BGM play control box. If so, the procedure proceeds to step 315; and, if not, the procedure proceeds to step 310.

In step 315, as illustrated and described in regard to FIG. 4A, the navigation key is used to adjust the BGM play control box and thereby to control the BGM play operation. Examples of a function for control of playing background music are “Pause”, “Resume”, “Fast Forward (FF)”, “Rewind (REW)”, and “Stop”. Following step 315, the procedure moves to step 325, in which the apparatus determines if the BGM play control hotkey is pressed again. If so, the procedure proceeds to step 335; and, if not, the procedure returns to step 315.

If the BGM play control key is not pressed again, as determined in step 325, the navigation key continues to be used for control of the BGM play operation until the BGM play control key is pressed again in step 315.

In step 335, the apparatus terminates the displaying of the BGM play control box and converts the navigation key into the original mode.

Meanwhile, if the navigation key is not set to adjust the BGM play control box, the procedure proceeds to step 310, so that a combination of numeric keys is used to adjust the BGM play control box and thereby to control the BGM play operation, as illustrated in FIG. 4B. Examples of a function for control of playing background music are “Pause”, “Resume”, “Fast Forward (FF)”, “Rewind (REW)”, and “Stop”.

In step 320, the apparatus determines if the BGM play control hotkey is pressed again. If so, the procedure proceeds to step 330; and, if not, the procedure returns to step 310.

If the BGM play control key is not pressed again (in step 320), the navigation key continues to be used for control of the BGM play operation until the BGM play control key is pressed again (in step 310).

In step 330, the apparatus terminates the displaying of the BGM play control box and converts a combination of the numeric keys into the original modes.

As described above, the BGM play control operation can be adjusted using the predetermined hotkey without converting the BGM play operation into the main operation. Accordingly, it is possible to prevent the user from being inconvenienced by converting the BGM play operation into the main operation.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for controlling a background music (BGM) play operation that is performed in a background mode in a mobile communication system, the method comprising the steps of:
determining if a predetermined hotkey is pressed during the BGM play operation;
if the predetermined hotkey is pressed, displaying a BGM play control box while maintaining an ongoing main operation state;
changing function mapping of a series of predetermined keys;
determining if a predetermined key is pressed for control of the BGM play operation; and
if the predetermined key is pressed, controlling the BGM play operation according to the mapped function of the pressed key.

2. The method of claim 1, further comprising:
converting the mapped functions of the predetermined keys to original functions if the predetermined hotkey is pressed again after the step of controlling the BGM play operation; and
terminating the displaying of the BGM play control box.

3. The method of claim 1, wherein the mapped functions of the predetermined keys are “Pause”, “Resume”, “Fast Forward (FF)”, “Rewind (REW)”, and “Stop”.

4. The method of claim 1, wherein the BGM play operation continues to be performed in a background mode during the step of controlling the BGM play operation.

5. The method of claim 1, wherein, during the step of displaying the BGM play control box the mapped functions of one of the predetermined keys and a key array corresponding to the mapped functions are displayed.

6. An apparatus for controlling a background music (BGM) play operation that is performed in a background mode in a mobile communication system, the apparatus comprising:
a controller for commanding, upon detection of pressing of a predetermined hotkey, a BGM processor to control the BGM play operation while maintaining an ongoing main operation state; and
the BGM processor for displaying a BGM play control box in response to the BGM play control command from the controller and controlling the BGM play operation upon detection of pressing of a series of predetermined keys to which functions for control of the BGM play operation are mapped.

7. The apparatus of claim 6, wherein, upon detecting the pressing of the predetermined hotkey again, the controller commands the BGM processor to terminates displaying of the BGM play control box and controlling of the BGM play operation.

8. The apparatus of claim 7, wherein, upon receipt of the termination command from the controller, the BGM processor terminates the displaying of the BGM play control box and converts the mapped functions of the predetermined keys to original functions.

9. The apparatus of claim 6, wherein the mapped functions of the predetermined keys are “Pause”, “Resume”, “Fast Forward (FF)”, “Rewind (REW)”, and “Stop”.

10. The apparatus of claim 6, wherein the BGM processor controls of the BGM play operation in a background mode upon detection of the pressing of the predetermined keys.

11. The apparatus of claim 6, wherein the BGM play control box displays the mapped functions of one of the predetermined keys and a key array corresponding to the mapped functions.

12. A method for controlling a background music (BGM) play operation in a mobile communication system, the method comprising the steps of:
identifying an input of controlling a BGM play operation while maintaining the BGM play operation; and
controlling the BGM play operation according to the mapped function of the input.

13. The method of claim 12, wherein the mapped functions of the input are “Pause”, “Resume”, “Fast Forward (FF)”, “Rewind (REW)”, and “Stop”.

14. The method of claim 12, wherein the BGM play operation continues to be performed in a background mode during the step of controlling the BGM play operation.

15. A mobile communication terminal for controlling a background music (BGM) play operation comprising:
means for identifying an input of controlling a BGM play operation while maintaining the BGM play operation; and
means for controlling the BGM play operation according to the mapped function of the input.

16. The mobile communication terminal of claim 15, wherein the mapped functions of the input are “Pause”, “Resume”, “Fast Forward (FF)”, “Rewind (REW)”, and “Stop”.

17. The mobile communication terminal of claim 15, wherein the BGM play operation continues to be performed in a background mode during the controlling the BGM play operation.
